(19) United States
(12) Patent Application Publication
(10) Pub. No.: US 2010/0214655 A1
(43) Pub. Date: Aug. 26, 2010

(54) Telescopic device capable of rapidly switching eyepieces

(76) Inventor: Su-Min Kung, His Chih City (TW)

Correspondence Address: Jackson Intellectual Property Group PLLC, 106 Starvale Lane, Shipman, VA, 22971, US

(21) Appl. No.: 12/010,890

(22) Filed: Jan. 30, 2008

(30) Foreign Application Priority Data
Jan. 4, 2008 (TW) 097200183

(51) Int. Cl. G02B 23/00

(52) U.S. Cl. 359/425

(57) ABSTRACT

A multi-functional telescopic device is disclosed which can be used as an optical telescope for general long-distance observation and astronomical observation or as a magnifying glass. More particularly, the telescopic device allows for rapidly switching a terminal eyepiece between long-distance observation and a horizontal eyepiece for astronomical observation. The telescopic device is characterized in that a rapidly switching reflective mirror is provided to an end of the terminal eyepiece and the horizontal eyepiece, so that a user can directly rotate an external switching knob to selectively switch the terminal eyepiece and the horizontal eyepiece. As a result, the user can not only observe remote objects conveniently, but also watch the stars directly through the horizontal eyepiece without having to look upwards at a large elevation angle.

### BACKGROUND OF THE INVENTION

1. Technical Field

The present invention relates to an optical telescope for general long-distance observation and astronomical observation or for use as a magnifying glass. More particularly, the present invention relates to a telescopic device comprising a terminal eyepiece for long-distance observation and a horizontal eyepiece for astronomical observation, wherein the two eyepieces may be rapidly switched from one to the other by rotating a switching knob.

2. Description of Related Art

Generally, a telescope is an elongated columnar device for magnifying an image of a distant object and comprises a convex objective lens at a distal end thereof and a terminal eyepiece at a proximal end thereof, so that a user can view the distant object when the image is in focus. While a user may have no problems looking through the terminal eyepiece to view remote objects which are approximately on a same horizontal plane with the user or within a relative small viewing angle, such as, for instance, scenery, buildings and birds, if the user wants to watch the stars or the moon and can only do so by looking through the terminal eyepiece, the user will have to lower his or her body to a great extent or bend down so that the user's eyes are close enough to the terminal eyepiece for view-finding, which is extremely inconvenient to the user.

In order to overcome the above-mentioned problem with view-finding at a large elevation angle, the telescope industry has developed a two-way telescope which has a terminal eyepiece as well as a horizontal eyepiece, wherein an attachable and exchangeable horizontal eyepiece is installed on an upward tube surface of the telescope, so that a user can make astronomical observations comfortably for a long time, that is, with the telescope set at a large elevation angle but without the user having to look upwards at a large elevation angle.

Although the two-way telescope mentioned above has the horizontal eyepiece to facilitate astronomical observation, the horizontal eyepiece is externally or exchangeably attached to the telescope, so that it remains inconvenient to use the telescope. Even in a pending patent application by the inventor of the present invention for an invention comprising a terminal eyepiece and a horizontal eyepiece which are switchable from one to the other for use, the terminal eyepiece is still disposed independently behind a switching component and thereby significantly limits the overall design of a telescope. Therefore, similar conventional products still possess a large room for improvement.

In view of the shortcomings of conventional telescopes, and based on years of experiences in designing and manufacturing various optical devices, the present inventor has successfully developed a telescopic device capable of rapidly switching eyepieces as disclosed herein.

### SUMMARY OF THE INVENTION

The present invention provides an optical telescopic device for general long-distance observation and astronomical observation or for use as a magnifying glass. More particularly, the present invention allows for rapidly switching a terminal eyepiece for long-distance observation and a horizontal eyepiece for astronomical observation. The present invention is characterized in that the telescopic device is provided with both the terminal eyepiece and the horizontal eyepiece, and a rapidly switching reflective mirror is provided at a location where the terminal eyepiece and the horizontal eyepiece converge, so that a user can directly rotate an external switching knob to selectively switch the terminal eyepiece and the horizontal eyepiece. As a result, the user observe remote objects conveniently, and watch heavenly bodies directly through the horizontal eyepiece without having to look upwards at a large elevation angle.

### BRIEF DESCRIPTION OF THE DRAWINGS

FIG. 1 is a perspective view of a telescopic device capable of rapidly switching eyepieces according to the present invention.

FIG. 2 is a perspective exploded view of the telescopic device capable of rapidly switching eyepieces according to the present invention.

FIG. 3 is an enlarged perspective view of the rotational switching mirror of the telescopic device according to the present invention.

FIG. 4 is a cross-sectional view showing operation of the rotational switching mirror of the telescopic device according to the present invention.

FIG. 5 is another cross-sectional view showing operation of the rotational switching mirror of the telescopic device according to the present invention.

### DETAILED DESCRIPTION OF THE PREFERRED EMBODIMENT

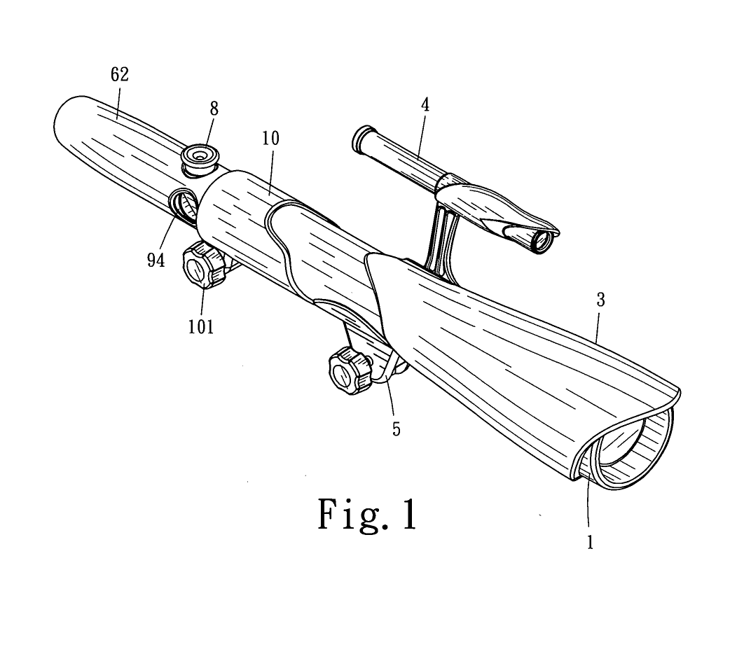

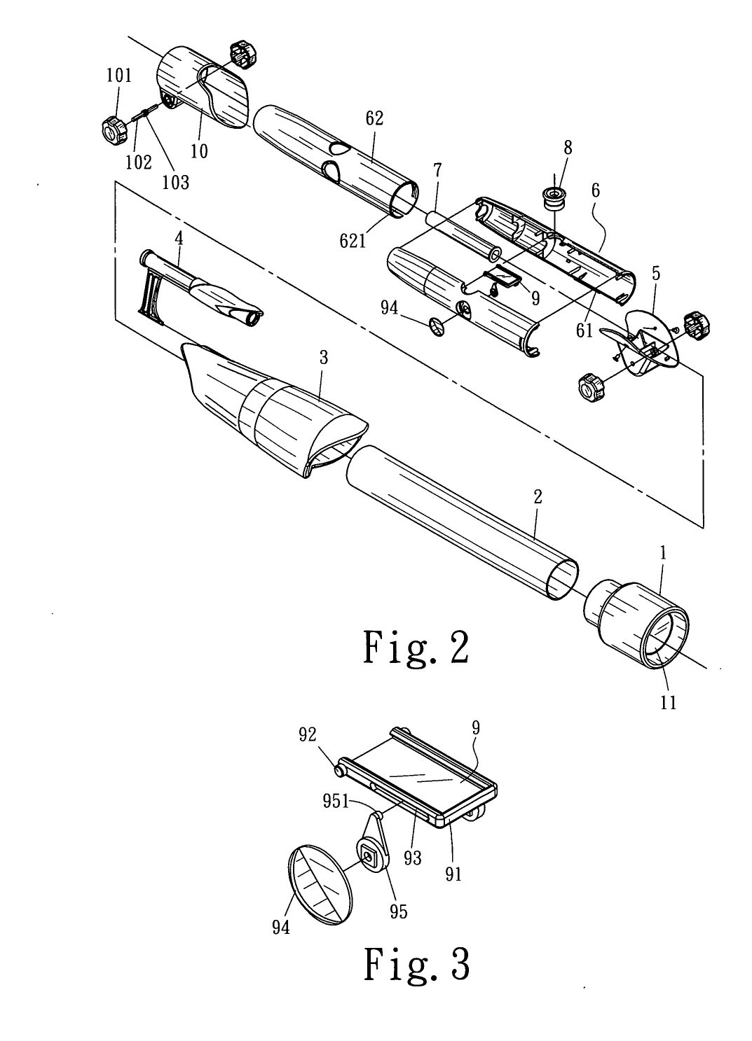

Referring to FIGS. 1 and 2, a telescopic device capable of rapidly switching eyepieces according to the present invention comprises an objective lens seat 1, a tube 2, a styling cover 3, a small telescope/magnifying glass 4, a mount 5, a telescoping tube 6, a terminal eyepiece 7, a horizontal eyepiece 8, a rotational switching mirror 9 and a styling sleeve 10.

The objective lens seat 1 is provided therein with a convex lens 11 and telescopically connected at an end thereof with the tube 2. The styling cover 3 is telescopically connected with an end of the tube 2 and has the small telescope/magnifying glass 4 fastened thereon. The small telescope/magnifying glass 4 can be used as a small telescope, or detached from the styling cover 3 for use as a magnifying glass for viewing documents or examining tiny objects. The mount 5 is fixedly attached to a lower tube wall of the tube 2 for connecting with supporting legs.

The telescoping tube 6 is composed of corresponding halves and defines an accommodating space in which the terminal eyepiece 7 and the horizontal eyepiece 8 are secured and the rotational switching mirror 9 is axially positioned. The telescoping tube 6 is further provided with a rack 61 at a lower portion thereof and a translucent sleeve 62 surrounding the telescoping tube 6. The translucent sleeve 62 has a slot 621 located thereon corresponding to the rack 61 while the styling sleeve 10 is telescopingly connected to an end of the translucent sleeve 62. A turning knob 101 is attached to a bottom portion of the styling sleeve 10 and further connected with a rotating shaft 102 having a gear 103 attached thereon. The gear 103 is engaged with the rack 61 so that, when the turning knob 101 is rotated, the gear 103 drives the telescoping tube 6 to move for focusing.

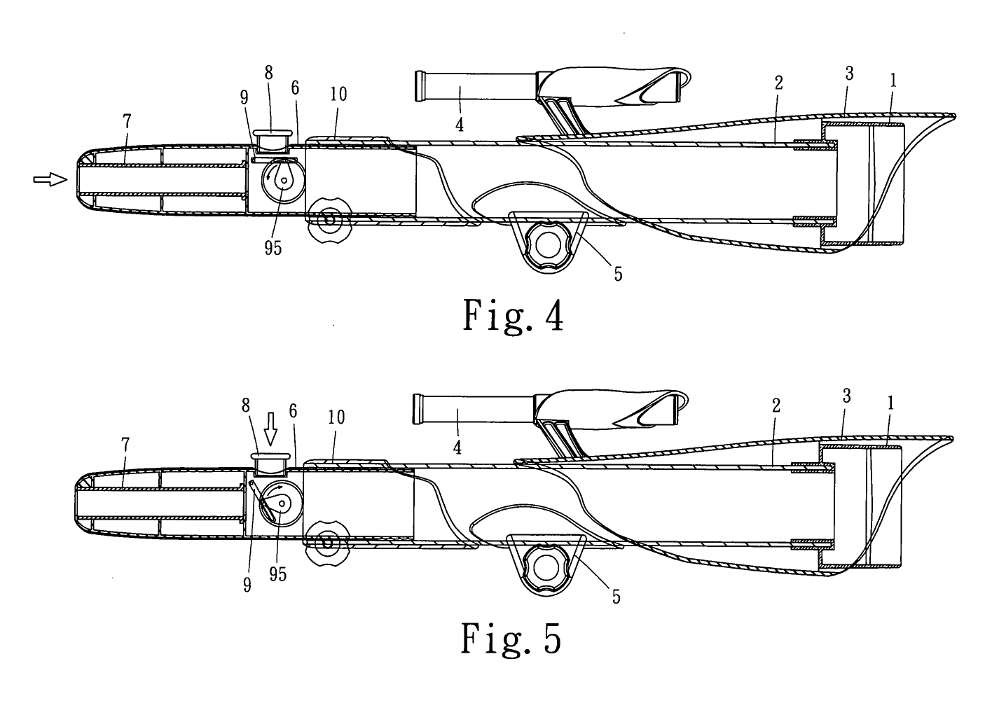

Referring to FIGS. 3, 4 and 5, the rotating switching mirror 9 in the telescoping tube 6 is provided with a frame 91 which has a pivot pin 92 on each of two sides thereof, wherein the pivot pins 92 are pivotally attached to an inner wall of the telescoping tube 6. The frame further has a sliding groove 93. A switching knob 94 is fixedly attached with an eccentric arm 95 located inside the telescoping tube 6 corresponding to the rotating switching mirror 9. The eccentric arm 95 is formed with a driving pin 951 at an end thereof that extends into the sliding groove 93 of the frame 91.

According to the above-mentioned structure of the telescopic device of the present invention, the rotating switching mirror 9 may be rotated to a horizontal position by rotating the switching knob 94, so that a user can look into the terminal eyepiece 7 and view a distant object through the objective lens seat 1 after focusing. (At this time, the horizontal eyepiece 8 is not in use.) When it is desired to watch a heavenly body located at a large elevation angle, all the user has to do is directly rotate the switching knob 94 to thereby rotate the rotating switching mirror 9 to an appropriately inclined position, so that the user can look into the horizontal eyepiece 8 and, via reflection, watch the sky through the objective lens seat 1 after focusing. (At this time, the terminal eyepiece 7 is not in use.)

Thus, the telescopic device capable of rapidly switching eyepieces according to the present invention allows for rapidly switching the terminal eyepiece for long-distance observation and the horizontal eyepiece for astronomical observation by directly rotating the switching knob.

What is claimed:

1. A telescopic device capable of rapidly switching eyepieces comprising an objective lens seat 1, a tube 2, a styling cover 3, a small telescope/magnifying glass 4, a mount 5, a telescoping tube 6, a terminal eyepiece 7, a horizontal eyepiece 8, a rotational switching mirror 9 and a styling sleeve 10, wherein the objective lens seat 1 is provided therein with a convex lens 11 and telescopically connected at an end thereof with the tube 2; the styling cover 3 is telescoping connected with an end of the tube 2 and has the small telescope/magnifying glass 4 fastened thereon,
wherein the small telescope/magnifying glass 4 can be used as a small telescope, or detached from the styling cover 3 for use as a magnifying glass for viewing documents or examining tiny objects; the mount 5 is fixedly attached to a lower tube wall of the tube 2 for connecting with supporting legs; the telescoping tube 6 is composed of corresponding halves and defines an accommodating space in which the terminal eyepiece 7 and the horizontal eyepiece 8 are secured and the rotational switching mirror 9 is axially positioned; the telescoping tube 6 is further provided with a rack 61 at a lower portion thereof and a translucent sleeve 62 surrounding the telescoping tube 6; the translucent sleeve 62 has a slot 621 located thereon corresponding to the rack 61 while the styling sleeve 10 is telescopically connected to an end of the translucent sleeve 62; and a turning knob 101 is attached to a bottom portion of the styling sleeve 10 and further connected with a rotating shaft 102 having a gear 103 attached thereon, wherein the gear 103 is engaged with the rack 61 so that, when the turning knob 101 is rotated, the gear 103 drives the telescoping tube 6 to move for focusing.

2. The telescopic device as claimed in claim 1, wherein the rotating switching mirror 9 in the telescoping tube 6 is provided with a frame 91 which has a pivot pin 92 on each of two sides thereof, the pivot pins 92 being pivotally attached to an inner wall of the telescoping tube 6; the frame further has a sliding groove 93; a switching knob 94 is fixedly attached with an eccentric arm 95 located inside the telescoping tube 6 corresponding to the rotating switching mirror 9; and the eccentric arm 95 is formed with a driving pin 951 at an end thereof which extends into the sliding groove 93 of the frame 91; and wherein the rotating switching mirror 9 can be rotated to a horizontal position or an appropriately inclined position by rotating the switching knob 94, so that a user can either look into the terminal eyepiece 7 and view a distant object through the objective lens seat 1 after focusing, or alternatively, look into the horizontal eyepiece 8 and, via reflection, watch the sky through the objective lens seat 1 after focusing.
